(19) United States
(12) Patent Application Publication
(10) Pub. No.: US 2004/0254037 A1
(43) Pub. Date: Dec. 16, 2004

(54) Self-tensioning drive assembly configuration & methodology

(76) Inventors: Scott A. Williamson, New Hope, MN (US); Richard D. Williamson, New Brighton, MN (US)

Correspondence Address: NAWROCKI, ROONEY & SIVERTSON, SUITE 401, BROADWAY PLACE EAST, 3433 BROADWAY STREET NORTHEAST, MINNEAPOLIS, MN, 554133009

(21) Appl. No.: 10/459,028

(22) Filed: Jun. 10, 2003

(51) Int. Cl. F16H 7/14; F16H 7/08; F16H 7/00

(52) U.S. Cl. 474/114; 474/148; 474/101

(57) ABSTRACT

A drive assembly for a driven device having an input shaft is provided, including an attendant methodology for optimally configuring components thereof so as to minimize instability without recourse to utilization of a pivot regulating mechanism. The drive assembly includes a driving device having an output shaft, a driving device support structure, and a drive operatively linking the output shaft of the driving device with the input shaft of the driven device. The driving device support structure includes an anchorable base and a selectively positionable platform pivotable, with respect to the base, about a pivot axis so as to thereby define a tilt angle α for the platform relative to a horizon. The drive including a drive sheave, a driven sheave, and an endless loop, a hub load being generated by the endless loop about the sheaves and acting therebetween along a hub load line. The hub load line has an angular relationship e relative to the horizon. The tilt angle α is preferably within the range of about 15 to 35°, the hub load line angle θ preferably being within the range of about 5 to 35° such that optimal tension for the endless loop is achieved, thereby substantially eliminating deleterious instability for the drive assembly.

### TECHNICAL FIELD

The present invention generally relates to a configuration of a self-tensioning drive assembly, more particularly, to an arrangement of drive assembly components (e.g., a driving device, a pivotable support structure for same, and a drive operatively linking an output shaft of the driving device to an input shaft of a driven device) which minimizes drive instability without recourse to restraint or regulation of the self-tensioning mechanism.

### BACKGROUND OF THE INVENTION

It is commonly known to utilize a motor to drive a device by attaching a continuous belt between the motor and the device to be driven. One problem encountered with regard to motor assemblies that utilize drive belts is that when the motor begins to turn the belt, there is an increase in the tension of the belt, and once the motor is up to operating speed, the belt tension decreases. This problem increases and decreases the stretch of the belt, and over time, reduces the life of the belt, occasionally breaking the belt when the tension becomes too great, or when the belt becomes weakened from excessive stretching. Additionally, there are a wide range of other detrimental problems that may result from a design that permits significant changes in belt tension, or permits a loose fitting belt, such as, for example, noise, vibration and potentially harmonic resonance, uncoupling of the belt from the motor and/or driven device, and reduction in motor bearing life. Since maintaining proper belt tension allows for higher motor efficiency and longer belt life, anything that permits the belt to greatly slacken and/or stretch should be avoided.

One solution to these problems has been to provide an assembly wherein the motor pivots so that, as the belt drive slackens, the motor pivots away from the driven device, thereby tightening the belt. However, with a freely pivotable design, the motor is not prevented from pivoting toward the driven device, nor is the movement of the motor limited or otherwise regulated (e.g., restrained, damped, etc.) in any way. This typically results in the motor bouncing due to the alternating slacking and tightening of the belt drive acting between the drive and driven sheaves. In this way, the problem has changed from merely having a moving belt, to involving a moving belt and motor. With this arrangement, the problems of noise, vibration, and potentially harmonic resonance may also be evident in the motor itself. Additionally, the motor adds mass to the moving system, and thus exacerbates stretching of the belt.

Heretofore known corrective measures for drive assembly instability wherein a pivot base is used have included the addition of restraining or limiting means to the pivot base so as to counteract or selectively counterbalance the tensioning effect of the pivot base (i.e., prevent or limit the motor from pivoting back toward the driven device or otherwise control the “negative” pivot of the base towards the driven device, that is to say, in a belt slackening direction). Although such corrective measures have been generally accepted, and continue to be actively and further pursued, a preventative measure, whereby the instability is avoided in the first instance, is highly desirable and advantageous.

In furtherance of a preventative measure focused upon a configuration of self-tensioning drive assembly components which suitably minimizes instability, the drive assembly geometry, mechanics, and dynamics (i.e., the assembly components themselves, and their interrelationships) require scrutiny. More particularly, the nature of the driving device, functionality of the pivot base, and general character of the drive operatively linking an output shaft of the driving device with the input shaft of the driven device must be analyzed, and better understood/appreciated. A discussion of same in the context of air moving follows.

A fan is selected to move or deliver a volumetric rate of air to or through a “system.” The fan is generally selected based on the time rate volumetric flow as well as the pressure required to be generated. Typically, there are a variety of fans (i.e., differing types and sizes) which can satisfy the specified or sought after performance requirements. For a given fan selection, it is necessary to provide some specific power to the fan in order for the fan to operate at the requirements. Many applications use a belt drive system with an electric motor to transmit power to the fan.

Motors are generally selected such that the motor will be able to supply at least the power required by the fan, with other criteria also influencing motor selection for a given application. There are many different commercial electric motor manufacturers, with each motor manufacturer typically having more that one motor that meets the sought after performance criteria. Each available motor characteristically has a unique mass, and is further likely to have unique dimensions.

Having selected the motor for supplying power to the fan, a drive must next be specified. Drives are selected based primarily on the power required to be transmitted, the speed ratio from the drive (i.e., motor) to the driven (i.e., fan) sheaves, and the center distance from the drive to driven sheaves (i.e., the center distance between sheaves). There are many different commercial belt drive manufacturers, and each manufacturer likely to have multiple drive selections available for any particular requirement. Each potential drive selection will have its own drive/driven pitch diameters, belt quantity, belt length, belt cross section, required hubload, and maximum hubload.

There are practically an infinite number of fan-motor-drive permutations available for a given belt drive system. Desirably, the motor may be mounted on a pivot base in belt drive applications. As the belt drive slackens with use, the motor pivots or tilts away from the driven device, thereby tightening the belt. Pivot bases may also be referred to as self-adjusting or self-tensioning motor bases. When a pivot base is requested for the motor, the complete drive system must be analyzed to ensure proper power transmission and smoothly running drives. Each system must be analyzed on a case by case basis due to all the motor/drive permutations available for a system.

With belt drive applications, a minimum hubload must be supplied to the drive for the drive to transmit power to the fan from the motor without the belts slipping in/on the sheaves. The advantage to mounting the motor to a pivot base is that the drive system is self-tensioning: the drive system can be arranged so that the weight and torque of the motor will supply the hubload required to transmit the power through the drive, even after the belts stretch and/or wear.

A known shortcoming of pivot base motor mounts is that if the belts hop or flutter, they can come free of the sheaves. It is not uncommon to see pivot bases with mechanisms such as springs, backstops, etc. added in an effort to supply the required hubload and to prevent hop or flutter (e.g., U.S. Pat. No. 5,921,876 which discloses a base capable of pivoting only in a direction away from the driven device).

With a pivot base application, supplying the required hubload is only a single consideration in furtherance of ensuring stable drive operation, other considerations, factors or givens include, but are not limited to: (1) The drive will not operate in a condition such that the tensions in the belt(s) resulting from transmission of the power create a moment about the pivot point greater than the moment about the pivot point created by the weight of the motor; (2) The moments about the pivot point of the pivot base act in such a way that the belt(s) will increase in tension; (3) At rest, the belt tensions on the ‘top’ of the drive equals the tension on the ‘bottom’ side, while, when transmitting torque, there is a tight side tension and a slack side tension, the ratio therebetween must fall within a certain range for successful operation; (4) The total hubload supplied to the drive must not exceed the maximum allowed by the drive or motor and fan bearings; and, (5) The natural frequency of the belt(s) must not approximate any of the frequencies generated by the drive system. Thus, recognition, appreciation and development of these, and other considerations, are essential for the advancement and formulation of a self-tensioning drive assembly configuration methodology, and appurtenant drive assembly configuration, which provide a heretofore unknown critical operational stability for a self-tensioning drive assembly.

### SUMMARY OF THE INVENTION

An optimal self-tensioning drive assembly for a driven device having an input shaft is provided. The assembly preferably includes a driving device having an output shaft, a driving device support structure, and a drive operatively linking the output shaft of the driving device with the input shaft of the driven device. The driving device support structure includes an anchorable base and a selectively positionable platform pivotable, with respect to the base, about a pivot axis so as to thereby define a tilt angle α for the platform relative to a horizon, the angle α preferably being within the range of about 15 to 35°. The drive includes a drive sheave, a driven sheave, and an endless loop, a hubload being generated by the endless loop about the sheaves and acting therebetween along a hubload line. The hubload line has an angular relationship θ relative to the horizon, the hubload line angle θ preferably being within the range of about 5 to 35°. With the tilt angle α and hubload line angle θ so defined, an optimal tension for the endless loop is achieved, thereby substantially eliminating deleterious instability for the self-tensioning drive assembly without recourse to use of a pivot regulating mechanism.

More specific features and advantages obtained in view of those features will become apparent with reference to the drawing figures and DETAILED DESCRIPTION OF THE INVENTION.

### BRIEF DESCRIPTION OF THE DRAWINGS

FIG. 1 illustrates a self-tensioning driving device of a drive assembly;

FIGS. 2-4 illustrate physical relationships between select elements of the assembly components of FIG. 1;

FIG. 5 illustrates static load relationships of the drive of the assembly of FIG. 1;

FIG. 5A illustrates dynamic load relationships of the drive of the assembly of FIG. 1; and,

FIG. 6 illustrates a methodology, vis-a-vis a process flow schematic, for optimally configuring a self-tensioning drive assembly.

### DETAILED DESCRIPTION OF THE INVENTION

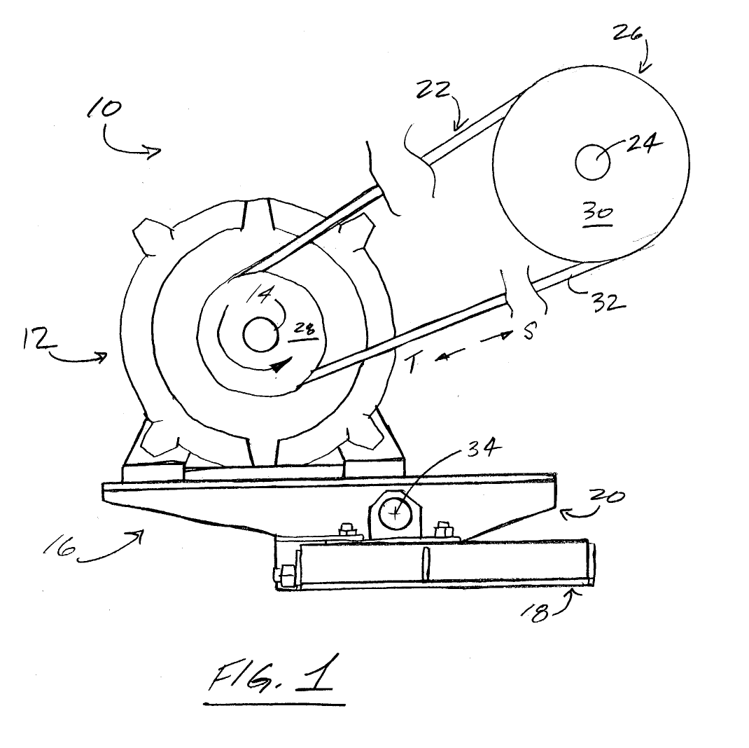

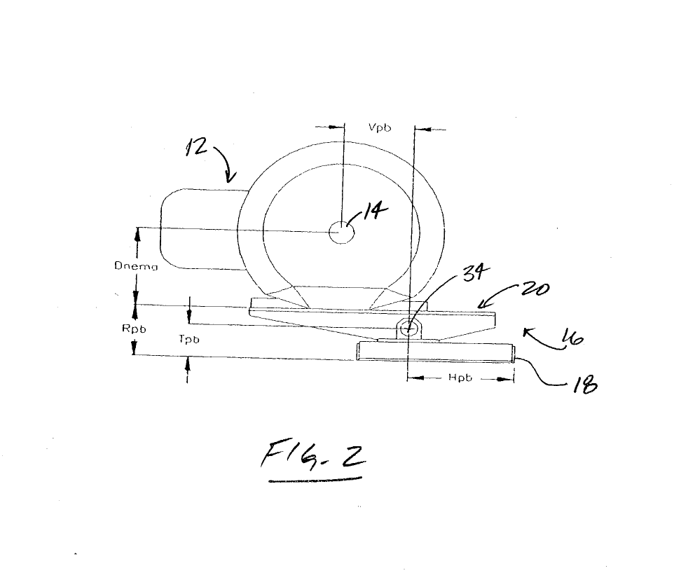

The subject invention provides an optimal self-tensioning drive assembly, more particularly a configuration thereof, for a driven device, including an attendant configuration methodology, such that drive instability is minimized (i.e., the heretofore known problem of, for example, belt hop or flutter are avoided, without directional restraint, limitation, regulation or other modification of the self-tensioning mechanism). A characteristic self-tensioning drive assembly is generally shown in FIG. 1, with FIGS. 2-5 illustrating general relationships between select elements the drive assembly of FIG. 1, select interrelationships, as will be subsequently discussed, being essential to the self-tensioning drive assembly configuration of the subject invention.

With general reference to FIG. 1, there is shown a characteristic self-tensioning drive assembly 10. The self-tensioning drive assembly generally includes a driving device 12, such as a motor, having an output shaft 14, supported upon or by a driving device support structure 16 which preferably includes an anchorable base 18 and a selectively positionable platform 20. A drive 22 operatively joins the output shaft 14 of the driving device 12 with an input shaft 24 of a driven device 26, the drive 22 generally including a drive sheave 28, a driven sheave 30, and an endless loop 32 such as a belt.

As previously noted, the driving device support structure 16 of the subject assembly 10 generally includes an anchorable base 18 and a selectively positionable platform 20 pivotable, with respect to the base 18, about a pivot axis 34. Directional movement of driving device 12, mounted in a manner so as to provide a self-tensioning drive assembly, may be generally characterized as being in either a belt tensioning direction (T), a direction distal to driven device 26, or, in a belt slackening direction (S), a direction proximal to driven device 26. Preferably, but not necessarily, the driving device 12 is selectively affixed to the platform 20, the platform 20 being operatively engaged or engagable as previously outlined, or, more generally, as is well known to those of ordinary skill with same. It is to be understood that the platform may alternately be integrally formed with a housing of the driving device, or more generally, the functionality of the platform (i.e., pivoting or tilted support) may be incorporated into the driving device so as to eliminate such structure from the driving device structure as described.

With particular reference to FIG. 2, several physical relationships between the driving device 12 and the preferred driving device support structure 16, and/or inherent with each, are noted. Typically, and preferably, the driving device 12 is variably positionable with respect to the platform 20 of the support structure 16, the platform 20 in turn being variable positionable with respect to the base 18 thereof. More particularly, the platform 20 of the driving support structure 16 is translatable with respect to the base 18 thereof so as to define a variable offset distance (Hpb) between the pivot axis 34 of the support structure 16 and the base 18 thereof (i.e., the pivot point of the platform relative to the base is variable), and the driving device 12 is translatable with respect to the platform 20 upon which it is receivable so as to define a variable offset distance (Vpb) between the pivot axis 34 of the support structure 16 and the output shaft 14 of the driving device 12. Several inherent or fixed physical or spatial relationships are noted for the elements illustrated, more particularly, the height or thickness of the driving device support structure 16 (Rpb) (i.e., the distance between opposed parallel aligned exterior surfaces of the base and platform, or said another way, the distance between the “bottom” of base 18 and the “top” of platform 20 when oriented so as to be parallel); the height of, or distance between, the pivot axis 34 relative to the bottom of the base 18 (Tpb); and, the height or distance between the driving device output shaft 14 centerline and the top of the platform 20 (Dnema).

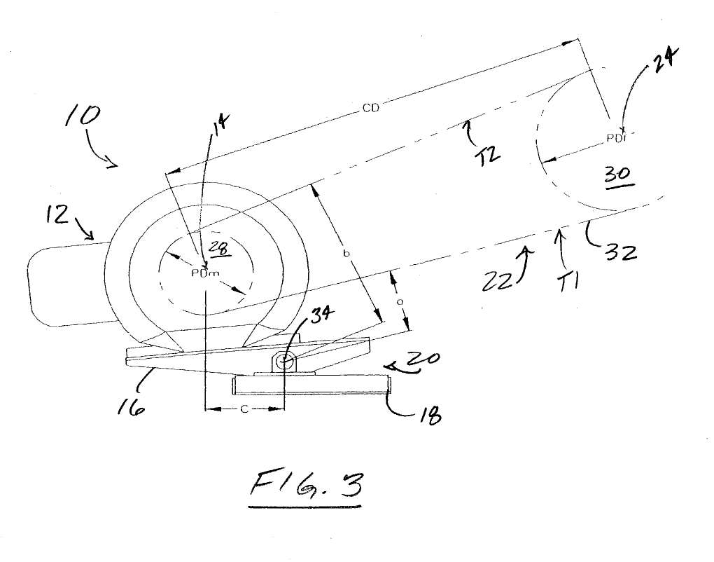

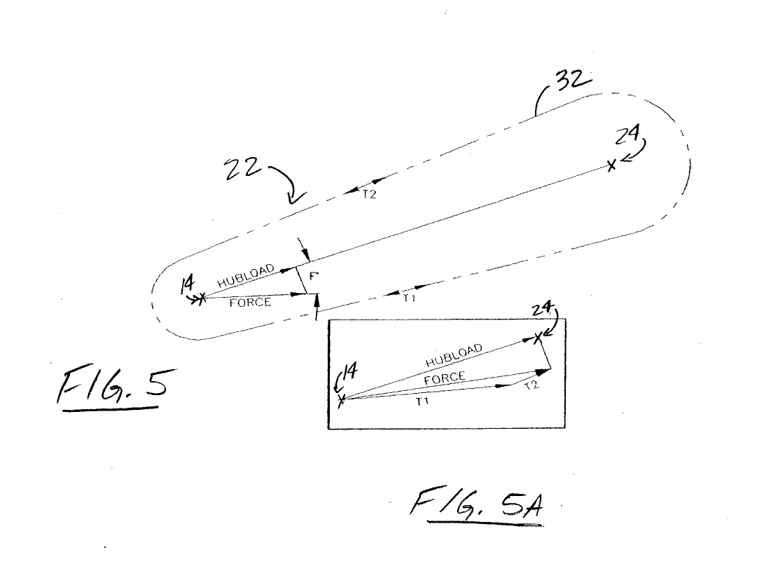

Referring now to FIG. 3, there is further illustrated spatial relationships and features of the self-tensioning drive assembly of FIG. 1, more particularly, relationships implicating the drive 22 of the assembly 10. As was previously outlined, the drive 22 generally includes the drive sheave 28, the driven sheave 30, and the endless loop 32, most typically, a belt. As is well known, the belt 32 is generally received within a notch of the outer periphery of the sheave. Pitch diameter (PD) is generally understood to be the dimension between exterior surfaces of the belt as received within the groove of the sheave, a value less than the outside diameter of the sheave. As to FIG. 3, the motor (i.e., drive) sheave 28 pitch diameter is designated PDm, whereas the fan (i.e., driven) sheave 30 pitch diameter is designated PDf. The center distance between the sheaves 28, 30 is designated CD, the hubload being a force acting along CD. The distance between the tension or tight (T1) and slack (T2) sides of the belt 32, relative to a line passing through the pivot axis 34 of the support structure 16 and parallel to the slack and tension sides of the belt, are designated a and b respectively, as shown. Further representations of the slack and tension components of the belt 32 are shown in FIGS. 5 and 5A which illustrate static and dynamic forces acting upon elements of the drive constituents.

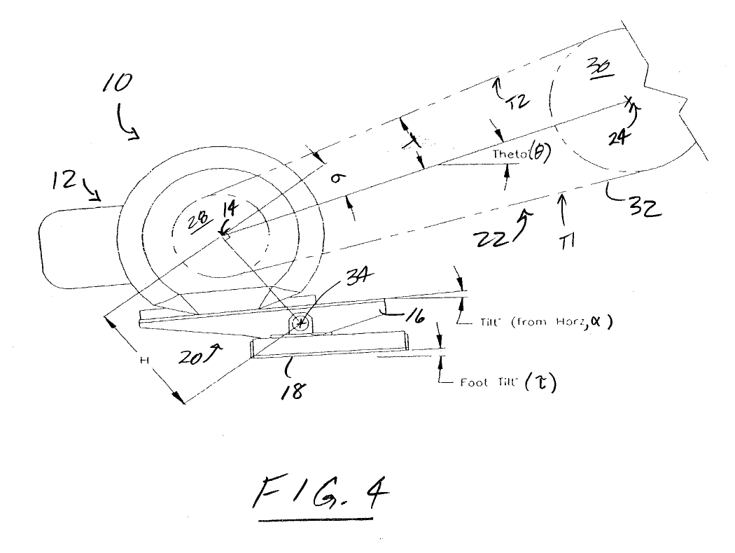

With reference now to FIG. 4, which identically shows the drive assembly elements of FIG. 3, several relationships implicating sheave arrangement are shown, as well as those relating to the driving device support structure components. The angular orientation of the hubload line (i.e., the vector representation of hubload which acts along line CD, that is to say, between the axes of the sheaves 28, 30) relative to the horizon is designated θ. The angular relationship between the slack or tension sides of the belt with line CD is designated λ. Finally, angle σ is related to an orthogonal projection of a line between the pivot axis 34 of the base 18 and the output shaft 14 of the driving device 12, more particularly, the angular relationship between said projection and the hubload line. The related dimension of line between the pivot axis 34 of the base 18 and the output shaft 14 of the driving device 12 is designated H.

Two important relationships involving the driving device support structure are shown, namely foot tilt (τ) and tilt angle (α). Foot tilt describes the angular relationship between the anchorable base 18 of the support structure 16 and the pad or other physical structure to which it is anchored. The tilt angle α is indicative of the quantum of pivoting or tilt of the selectively positionable platform 20 about the pivot axis 34, as measured with respect to the horizon.

With general reference now to FIGS. 3-5A, further discussion of the interplay between the driving device and the driven device, vis-a-vis the notions of hubload and belt tension, is warranted.

Hubload (HL) is generally a force acting along an imaginary line drawn between or linking the drive 28 and driven 30 sheaves (i.e., line CD). There are different hubload definitions needed for pivot base drive analysis, the following provided, but not intended to be limiting: (1) hubload required by the drives to transmit the power required (HLr); (2) maximum hubload allowed by the drive (HLm); (3) static hubload (HLs), a function of: PDm, PDf, CD, θ, motor weight, motor dimensions, pivot base dimensions, and pivot base tilt a; (4) dynamic hubload (HLd), a function of: PDm, PDf, CD, θ, motor torque, motor dimensions, pivot base dimensions, and pivot base tilt α; and, (5) total hubload (HLt), the sum of the static (HLs) and dynamic (HLd) hubload (i.e., HLt=HLs+HLd).

Belt tensions are the tension on the drive's tight side (T1), and the tension on the drive's slack side (T2), with the component of belt tension required for power transmission designated T1d and T2d respectively. The driving device supplies a torque to the drive manifested in or realized as the belt's equivalent tension (Te), wherein Te=T1−T2. Equivalent tension is a function of: motor torque, motor speed, and PDm; T1 and T2 are functions of: PDm, PDf, CD, Te and HLt; and, T1d and T2d are functions of: PDm, PDf, CD, Te, and HLr. Belt specific parameter such as belt free length and belt natural frequency are functions of: PDm, PDf, and CD; and, tension per belt and belt free length respectively.

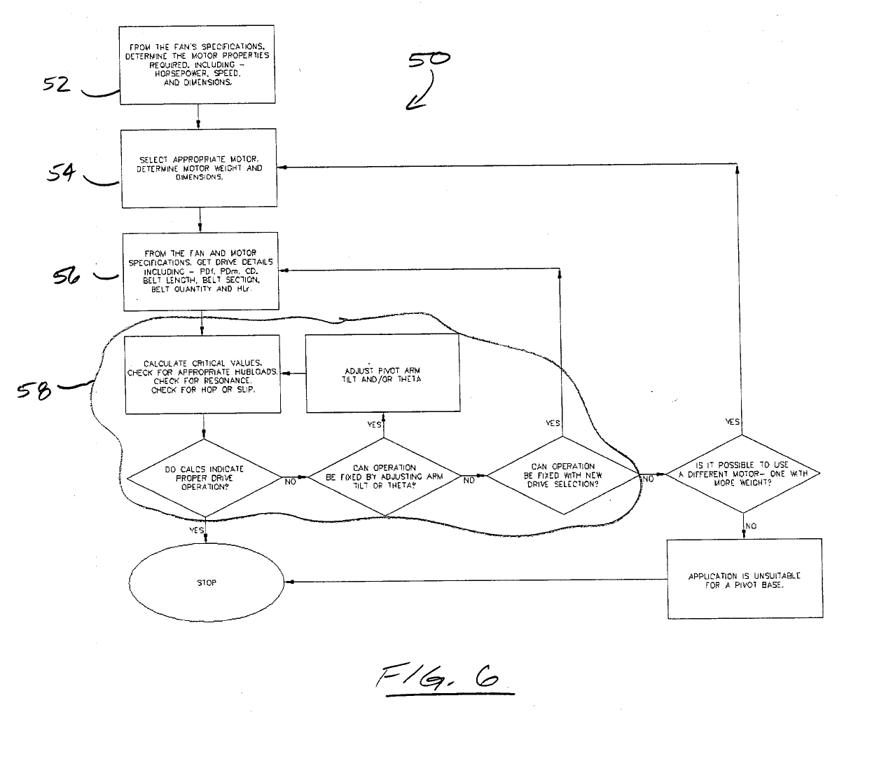

Referring now to FIG. 6, there is generally shown a process 50 for optimally configuring a self-tensioning drive assembly, and selecting components thereof. Subsequent to the preliminary steps of driven device 52 (e.g., and hereinafter, a fan) and driving device 54 (e.g., and hereinafter, a motor) selection, the self-tensioning drive assembly configuration determination proceeds with drive selection 56, and assessment 58. At this point a variety of information requires consideration, namely: motor character (e.g., weight, dimensions, & power generated, wherein the power generated is a function of the motor's torque and speed); pivot base character (e.g., pivot point location, arm length, tilt of the pivot arms); drive character, more particularly, drive sheave pitch diameter, PDm, driven sheave pitch diameter, PDf, belt(s) (e.g., length, quantity, & weight/length); center distance, CD, between sheaves; hubload required to transmit the power through the drive, HLr; maximum hubload allowed by the drive, HLm; and, the angular orientation of the line between the center of the sheaves and the horizon, perpendicular to gravity, θ. For a given application, the tilt of the pivot arms, the drive selection, and the angle θ are arguably easiest to change in furtherance of optimizing system configuration.

Integral to the configuration methodology of the subject invention is a pivot base analysis which implicates system geometry, mechanics, and dynamics, as will subsequently be outlined, and illustrated by way of example. The following calculations are important to the analysis: static hubload, HLs, dynamic hubload, HLd, total hubload, HLt, which is the sum of HLs and HLd, total belt tensions, T1 and T2, the components of belt tensions required for power transmission, T1d and T2d, moments about the pivot point resulting from the motor's weight, Mm, moments about the pivot point resulting from belt tensions T1 and T2, M1 and M2, moments about the pivot point resulting from the belt dynamic tensions T1d and T2d, M1d and M2d, and natural frequency of tight side belts, F1, and slack side belts, F2. Similarly, the following checks are critical to the process: (1) The moment about the pivot point from the weight of the motor must be greater than the sum of the moments that are a resultant from T1d & T2d (Mm>M1d+M2d); (2) The sum of the moments about the pivot point due to T1& T2 must be acting in an opposite direction than the moment due to the motor's weight, if Mm is negative, then M1+M2>0, and vice versa; (3) T1 and T2 must both be greater than zero; (4) HLs must be greater than or equal to HLr (HLs >=HLr); (5) HLt must not exceed HLm (HLt<=HLm); (6) The points at the centers of the drive and driven sheaves and the pivot point of the base must not be co-linear; and, (7) Both F1 and F2 must not be near the motor speed, fan speed, or the belt rotational speed to avoid resonance. Finally, the following system checks complete the preferred configuration methodology: (1) up to a point, static hubload, T1, T2, F1, & F2 can all be increased by increasing the tilt angle of the pivot arms; (2) F1 & F2 can be increased by shortening the distance between the drive sheave and driven sheave; (3) F1 & F2 can be increased by decreasing the belt quantity and vice-versa; (4) Decreasing θ may lower the moment generated by the belt tensions; and, (5) If the sum of the moments about the pivot due to T1& T2 act in the same direction as the moment due to the motor's weight, decrease the tilt of the pivot arms and/or increase θ. If a satisfactory configuration cannot be achieved, at least one value in the given section must be changed, and the system re-analyzed. Typically, a new drive selection is made and the system is re-analyzed. The following illustrative, non-limiting configuration examples (i.e., pivot base calculations and setup data) are provided, specification categories designated, motor, pivot base, drive, belts, geometry, mechanics, and dynamics:

EXAMPLE I: 5 Hp

EXAMPLE II: 60 Hp

EXAMPLE III: 75 Hp

EXAMPLE IV: 125 Hp

EXAMPLE V: 200 Hp

EXAMPLE VI: 250 Hp

As is readily appreciated, self-tensioning drive assemblies having a tilt angle α in the range of about between 15 and 35°, in combination with a hubload line angle θ in the range of about between 5 to 35°, yields an assembly stability heretofore unseen without regulation of the pivot motion of the support structure in the direction of the driven device. Preferably, a tilt angle α of between about 20 and 30°, and most preferably about 25° is most advantageous. Similarly, a hubload line angle θ of between 10 and 30°, and most preferably 20° is advantageous. Although not fully understood, the aforementioned configuration parameters are best suited when utilizing driving devices rated at about 3 to 250 Hp. Furthermore, it is advantageous and desirable that the offset Vpb be less than a maximum, and further advantageous that said offset be greater than a minimum, said offset most preferably being within the range of about 3 to 8 inches.

This invention disclosure provides a methodology and preferred self-tensioning drive assembly configurations which achieve sought after stable assembly operation and functionality without recourse to corrective measures heretofore known in the prior art. There are other variations of the subject invention, some of which will become obvious to those skilled in the art. It will be understood that this disclosure, in many respects, is only illustrative. Changes may be made in details, particularly in matters of shape, size, material, and arrangement of parts without exceeding the scope of the invention. Accordingly, the scope of the subject invention is as defined in the language of the appended claims.

PIVOT BASE CALCULATIONS
Job Name: Example
Fan S/N: Example1
Case/Rev.: 1
Fan Tag:
Fan Desc.:

| MOTOR | PIVOT BASE | DRIVE | BELTS |
|---|---|---|---|
| Frame: 184T | Hpb: 7.00 inches | CD: 20.20 inches | Section: A |
| RPM: 1780 | Rpb: 4.25 inches | PDf: 11.2 inches | Belt Qty.: 2 |
| BHP: 3.03 | Tpb: 2.75 inches | PDm: 8.2 inches | |
| Wgt: 128 lbf. | Vpb: 2.94 inches | Theta: 10° | |
| Dnema: 4.50 inches | Tilt: 20° | | |
| HP: 5.0 | Foot Tilt: 20° | | |

| GEOMETRY | MECHANICS | DYNAMICS |
|---|---|---|
| a: 0.9917 inches | Te: 26.17 lbf. | RPMf: 1303 |
| b: 9.7760 inches | T1: 80.25 lbf. | Belt speed: 3821 fpm |
| C: 4.8125 inches | T2: 54.08 lbf. | Driver: 29.7 Hz. |
| F: 0.83° | Dynamic Hubload: 19.87 lbf. | Driven: 21.7 Hz. |
| G: 36.09° | Static Hubload: 114.10 lbf. | Belt Pass: 13.7 Hz. |
| H: 6.6805 inches | Hubload: 133.96 lbf. | Tight Belt: 40.4 Hz. |
| Gamma: 4.26° | Force: 133.98 lbf. | Slack Belt: 33.2 Hz. |

[image] [image] PIVOT BASE CALCULATIONS
Fan S/N: 03-178272-1-1
Case/Rev.: 1
Fan Tag: 621-10-FAC-1
Fan Desc.: 402 AFPL

| MOTOR | PIVOT BASE | DRIVE | BELTS |
|---|---|---|---|
| Frame: 364T | Hpb: 12.13 inches | CD: 38.10 inches | Section: 5VX |
| RPM: 1780 | Rpb: 6.56 inches | PDf: 12.5 inches | |
| HP: 60 | Tpb: 4.25 inches | PDm: 10.3 inches | |
| Wgt: 948 lbf. | Vpb: 5.34 inches | Theta: 20° | |
| Dnema: 9.00 | Tilt: 25° | | |
| inches | Foot Tilt: 20° | | |

| GEOMETRY | MECHANICS | DYNAMICS |
|---|---|---|
| a: 5.4671 inches | Te: 412.51 lbf. | RPMf: 1467 |
| b: 16.1314 inches | T1: 727.00 lbf. | Belt speed: 4800 fpm |
| C: 9.6240 inches | T2: 314.48 lbf. | Driver: 29.7 Hz. |
| F: 0.66° | Dynamic Hubload: 196.57 lbf. | Driven: 24.4 Hz. |
| G: 30.28° | Static Hubload: 844.48 lbf. | Belt Pass: 10.2 Hz. |
| H: 12.5111 inches | Hubload: 1041.05 lbf. | Tight Belt: 60.2 Hz. |
| Gamma: 1.65° | Force: 1041.12 lbf. | Slack Belt: 39.6 Hz. |

[image] [image] PIVOT BASE CALCULATIONS
Job Name: Example
Fan S/N: —
Case/Rev.: Test 1
Fan Tag: —
Fan Desc.: —

| MOTOR | PIVOT BASE | DRIVE | BELTS |
|---|---|---|---|
| Frame: 405T | Hpb: 12.13 inches | CD: 55.00 inches | Section: 5VX |
| RPM: 1780 | Rpb: 6.56 inches | PDf: 18.7 inches | Belt Qty.: 4 |
| BHP: 75 | Tpb: 4.25 inches | PDm: 10.9 inches | |
| Wgt: 1308 lbf. | Vpb: 6.28 inches | Theta: 20° | |
| Dnema: 10.00 | Tilt: 18° | | |
| inches | Foot Tilt: 20° | | |
| HP: 100.0 | | | |

| GEOMETRY | MECHANICS | DYNAMICS |
|---|---|---|
| a: 6.6280 inches | Te: 487.26 lbf. | RPMf: 1038 |
| b: 18.3573 inches | T1: 861.79 lbf. | Belt speed: 5079 fpm |
| C: 9.7786 inches | T2: 374.53 lbf. | Driver: 29.7 Hz. |
| F: 1.60° | Dynamic Hubload: 211.96 lbf. | Driven: 17.3 Hz. |
| G: 25.03° | Static Hubload: 1021.25 lbf. | Belt Pass: 7.6 Hz. |
| H: 13.8221 inches | Hubload: 1233.21 lbf. | Tight Belt: 22.8 Hz. |
| Gamma: 4.07° | Force: 1233.70 lbf. | Slack Belt: 15.0 Hz. |

[image] [image] PIVOT BASE CALCULATIONS
Job Name: Example
Fan S/N: Example2
Case/Rev.: 2
Fan Tag:
Fan Desc.:

| MOTOR | PIVOT BASE | DRIVE | BELTS |
|---|---|---|---|
| Frame: 444T | Hpb: 12.13 inches | CD: 40.20 inches | Section: 5VX |
| RPM: 1750 | Rpb: 6.56 inches | PDf: 23.6 inches | Belt Qty.: 4 |
| BHP: 100.53 | Tpb: 4.25 inches | PDm: 14.0 inches | |
| Wgt: 1820 lbf. | Vpb: 5.00 inches | Theta: 15° | |
| Dnema: 11.00 | Tilt: 20° | | |
| inches | Foot Tilt: 15° | | |
| HP: 125.0 | | | |

| GEOMETRY | MECHANICS | DYNAMICS |
|---|---|---|
| a: 5.0010 inches | Te: 517.22 lbf. | RPMf: 1038 |
| b: 20.4676 inches | T1: 1061.84 lbf. | Belt speed: 6414 fpm |
| C: 9.2516 inches | T2: 544.62 lbf. | Driver: 29.2 Hz. |
| F: 2.22° | Dynamic Hubload: 282.18 lbf. | Driven: 17.3 Hz. |
| G: 25.59° | Static Hubload: 1312.79 lbf. | Belt Pass: 11.6 Hz. |
| H: 14.2205 inches | Hubload: 1594.97 lbf. | Tight Belt: 34.7 Hz. |
| Gamma: 6.86° | Force: 1596.16 lbf. | Slack Belt: 24.9 Hz. |

[image] [image] PIVOT BASE CALCULATIONS
Job Name: Example
Fan S/N: Example3
Case/Rev.: 3
Fan Tag:
Fan Desc.:

| MOTOR | PIVOT BASE | DRIVE | BELTS |
|---|---|---|---|
| Frame: 445T | Hpb: 12.13 inches | CD: 38.40 inches | Section: 5VX |
| RPM: 1750 | Rpb: 6.56 inches | PDf: 18.7 inches | Belt Qty.: 8 |
| BHP: 146.27 | Tpb: 4.25 inches | PDm: 11.8 inches | |
| Wgt: 2943 lbf. | Vpb: 5.88 inches | Theta: 10° | |
| Dnema: 11.00 | Tilt: 17° | | |
| inches | Foot Tilt: 10° | | |
| HP: 200.0 | | | |

| GEOMETRY | MECHANICS | DYNAMICS |
|---|---|---|
| a: 5.8760 inches | Te: 892.85 lbf. | RPMf: 1104 |
| b: 19.0162 inches | T1: 1782.96 lbf. | Belt speed: 5406 fpm |
| C: 9.5153 inches | T2: 890.11 lbf. | Driver: 29.2 Hz. |
| F: 1.73° | Dynamic Hubload: 421.39 lbf. | Driven: 18.4 Hz. |
| G: 30.83° | Static Hubload: 2240.87 lbf. | Belt Pass: 10.7 Hz. |
| H: 14.5532 inches | Hubload: 2662.26 lbf. | Tight Belt: 33.2 Hz. |
| Gamma: 5.15° | Force: 2663.47 lbf. | Slack Belt: 23.5 Hz. |

[image] [image] PIVOT BASE CALCULATIONS
Job Name: Example
Fan S/N: Example4
Case/Rev.: 4
Fan Tag:
Fan Desc.:

| MOTOR | PIVOT BASE | DRIVE | BELTS |
|---|---|---|---|
| Frame: 449T | Hpb: 11.00 inches | CD: 40.00 inches | Section: 5VX |
| RPM: 1750 | Rpb: 9.00 inches | PDf: 24.0 inches | Belt Qty.: 8 |
| BHP: 250 | Tpb: 5.25 inches | PDm: 14.0 inches | |
| Wgt: 2345 lbf. | Vpb: 8.00 inches | Theta: 15° | |
| Dnema: 11.00 | Tilt: 22° | | |
| inches | Foot Tilt: 20° | | |
| HP: 250.0 | | | |

| GEOMETRY | MECHANICS | DYNAMICS |
|---|---|---|
| a: 5.3407 inches | Te: 1286.23 lbf. | RPMf: 1021 |
| b: 21.7752 inches | T1: 2094.35 lbf. | Belt speed: 6414 fpm |
| C: 12.9429 inches | T2: 808.12 lbf. | Driver: 29.2 Hz. |
| F: 3.20° | Dynamic Hubload: 658.64 lbf. | Driven: 17.0 Hz. |
| G: 35.47° | Static Hubload: 2221.07 lbf. | Belt Pass: 11.6 Hz. |
| H: 16.7798 inches | Hubload: 2879.71 lbf. | Tight Belt: 34.7 Hz. |
| Gamma: 7.18° | Force: 2884.20 lbf. | Slack Belt: 21.5 Hz. |

[image]

[image]

1. A drive assembly for a driven device having an input shaft, said assembly comprising:
a. a driving device having an output shaft;
b. a driving device support structure comprising an anchorable base and a selectively positionable platform freely pivotable, with respect to said base, about a pivot axis so as to thereby define a tilt angle α for said platform relative to a horizon; and,
c. a drive operatively linking said output shaft of said driving device with the input shaft of the driven device, said drive including a drive sheave, a driven sheave, and an endless loop, a hub load being generated by said endless loop about the sheaves and acting therebetween along a hub load line, said hub load line having an angular relationship θ relative to the horizon; said tilt angle α being within the range of about 15 to 35°, said hub load line angle θ being within the range of about 5 to 35° such that optimal tension for said endless loop is achieved, thereby substantially eliminating deleterious instability for the drive assembly.

2. The drive assembly of claim 1 wherein said driving device is selectively translatable with respect to said platform so as to thereby define a variable offset distance between said output shaft of said driving device and said pivot axis of said support structure.

3. The drive assembly of claim 2 wherein said platform is translatable with respect to said base so as to thereby define a variable offset distance between said pivot axis of said support structure and said base thereof.

4. The drive assembly of claim 2 wherein said variable offset distance is less than a maximum variable offset distance.

5. The drive assembly of claim 2 wherein said variable offset distance is between a maximum and minimum variable offset distance.

6. The drive assembly of claim 5 wherein said variable offset distance is between about 3 and 8 inches.

7. The drive assembly of claim 3 wherein said driving device is rated at about 3 to 250 horsepower.

8. The drive assembly of claim 7 wherein said tilt angle α is between about 20 and 30°.

9. The drive assembly of claim 8 wherein said tilt angle α is about 25°.

10. The drive assembly of claim 8 wherein said hub load line angle θ is between about 10 and 30°.

11. A method of configuring a drive assembly for a driven device wherein the drive assembly includes a motor, a reversibly pivotal motor mount for supporting the motor, and a drive operatively uniting an input shaft of the driven device with an output shaft of the motor, said method comprising the steps of:
a. establishing a tilt angle α of between about 15 to 35°, said tilt angle α being a deviation from a horizon of the motor such that the motor is distally positionable from the driven device; and,
b. establishing an angle θ of between about 5 to 35°, said angle θ being a deviation from said horizon of a common plane comprising a driving sheave and a driven sheave of the drive.

12. The method of claim 11 comprising the further step of establishing an offset distance for a tilting platform upon a base of said pivotal motor mount, said offset distance defining a spatial relationship between the output shaft of the motor and a pivot axis of the tilting platform of the pivotal motor mount.

13. The method of claim 12 wherein said offset distance is selected so as to be neither a maximum nor a minimum.
